(19) United States
(12) Patent Application Publication
(10) Pub. No.: US 2013/0235377 A1
(43) Pub. Date: Sep. 12, 2013

(54) OPTICAL SENSOR AND IMAGE FORMING DEVICE

(71) Applicants: Toshihiro ISHII, Miyagi (JP); Yoshihiro Oba, Miyagi (JP); Fumikazu Hoshi, Tokyo (JP); Kazuhiko Adachi, Miyagi (JP); Satoru Sugawara, Miyagi (JP)

(72) Inventors: Toshihiro ISHII, Miyagi (JP); Yoshihiro Oba, Miyagi (JP); Fumikazu Hoshi, Tokyo (JP); Kazuhiko Adachi, Miyagi (JP); Satoru Sugawara, Miyagi (JP)

(73) Assignee: Ricoh Company, Ltd., Tokyo (JP)

(21) Appl. No.: 13/787,952

(22) Filed: Mar. 7, 2013

(30) Foreign Application Priority Data
Mar. 8, 2012 (JP) 2012-051096

(51) Int. Cl. G01N 21/21

(52) U.S. Cl. CPC G01N 21/21
USPC 356/369

(57) ABSTRACT

An optical sensor includes: a light emission module to emit a linearly polarized light beam having a first polarizing direction to a surface of an object in an incident direction inclined relative to a direction of a normal to the surface; a first photodetector module including a first photodetector disposed within a plane of incidence of the surface in an optical path inclined relative to an optical path of a light beam emitted from the light emission module and regularly reflected on the surface; and a second photodetector module including an optical element disposed within the plane of incidence of the surface in an optical path of a diffused reflection light beam from the surface to separate a linearly polarized light beam having a second polarizing direction perpendicular to the first polarizing direction, and a second photodetector to receive the light beam separated by the optical element.

### BACKGROUND OF THE INVENTION

1. Field of the Invention

The present disclosure generally relates to optical sensors and image forming devices, and more particularly to an optical sensor adapted for identifying a kind of a sheet, and an image forming device including the optical sensor.

2. Description of the Related Art

In image forming devices, such as digital copiers and laser printers, a toner image is transferred to a surface of a print medium, which is represented by a printing sheet, and the toner image is fixed by heating and pressurizing in predetermined conditions so that an image is formed. One of important factors that must be taken into consideration in image formation is the fixing conditions, such as the heating amount or pressure at the time of the fixing. In order to perform image formation with high quality, it is necessary to set up the fixing conditions individually according to the print media.

The image quality on printing sheets is greatly influenced by the material, thickness, humidity, smoothness, a coating state, etc., of the printing sheets. For example, regarding smoothness of a printing sheet, a fixing rate of toner to recesses of the microscopic irregularities in the surface of the printing sheet may be extremely lowered if the fixing conditions remain unchanged. In other words, unless appropriate fixing conditions are used for the kind of printing sheets, color irregularity will arise.

With development of image forming devices and diversification of representation methods in recent years, various kinds of print media or several hundreds of kinds of printing sheets exist. Further, with respect to each kind, there are also various brands with different sheet specifications, such as weighing capacity and thickness. In order to perform image formation with high quality, it is necessary to set up the fixing conditions individually according to each of these brands.

In recent years, the number of brands of printing sheets has been increasing more and more; for example, there are many brands for each of a plain printing sheet, a glossy coated sheet, a matte coated sheet, an art coated sheet, a plastic sheet, and a specialty sheet, such as an embossed-surface sheet.

With the existing image forming devices, a user has to set up the fixing conditions when performing a print job. For this reason, there has been an inconvenience that the user has to be familiar with the knowledge for identifying the kind of the printing sheet used and for inputting the setting items of the print job according to the kind of the sheet manually. If inappropriate setting items for the kind are input, it is difficult to obtain an image with the optimal image quality.

Japanese Laid-Open Patent Publication No. 2002-340516 discloses a surface property identifying device including a sensor which identifies the surface property of a surface of a printing material by contacting the sensor with the printing material surface and scanning the surface by a light beam from the sensor.

Japanese Laid-Open Patent Publication No. 2003-292170 discloses a printing device which detects a kind of a printing sheet from a pressure value detected by a pressure sensor in contact with the printing sheet.

Japanese Laid-Open Patent Publication No. 2005-156380 discloses a printing material discriminating device which discriminates the kind of a printing material using a reflected light beam and a transmitted light beam.

Japanese Laid-Open Patent Publication No. 10-160687 discloses a sheet material quality discriminating device which discriminates a sheet quality of a sheet material during movement based on the amount of a reflected light beam which is reflected on the surface of the sheet material, and the amount of a transmitted light beam which has transmitted through the sheet material.

Japanese Laid-Open Patent Publication No. 2006-062842 discloses an image forming device which has a discriminating unit which distinguishes the presence of a printing material contained in a feeding part and the presence of the feeding part based on the detection output from a reflection type optical sensor.

Japanese Laid-Open Patent Publication No. 11-249353 discloses an image forming device in which the quantities of two polarized light components of reflected light beams when a print medium is irradiated with light beams are detected, respectively, and the surface property of the printing medium is discriminated.

However, it is difficult for the image forming devices according to the related art to identify a kind of a sheet finely without increasing the device cost and the size.

### SUMMARY OF THE INVENTION

In one aspect, the present disclosure provides an optical sensor which is capable of identifying a kind of a sheet finely without increasing the device cost and the size.

In an embodiment which solves or reduces one or more of the above-described problems, the present disclosure provides an optical sensor including: a light emission module to emit a linearly polarized light beam having a first polarizing direction to a surface of an object in an incident direction inclined relative to a direction of a normal to the object surface; a first photodetector module including a first photodetector disposed within a plane of incidence of the object surface in an optical path inclined relative to an optical path of the light beam emitted from the light emission module and regularly reflected on the object surface; and a second photodetector module including an optical element disposed within the plane of incidence of the object surface in an optical path of a diffused reflection light beam from the object surface to separate a linearly polarized light beam having a second polarizing direction perpendicular to the first polarizing direction, and a second photodetector to receive the light beam having the second polarizing direction separated by the optical element.

Other objects, features and advantages of the present disclosure will become more apparent from the following detailed description when read in conjunction with the accompanying drawings.

### BRIEF DESCRIPTION OF THE DRAWINGS

FIG. 1 is a diagram for explaining the outline composition of a color printer according to an embodiment of the present disclosure.

FIG. 2 is a diagram for explaining the composition of an optical sensor according to an embodiment of the present disclosure for use in the color printer shown in FIG. 1.

FIG. 3 is a diagram for explaining a vertical cavity surface emitting laser array included in a light source of the optical sensor.

FIG. 4 is a diagram for explaining an incident angle of a light beam incident on a printing sheet.

FIG. 5 is a diagram for explaining the positions where two photcdetectors are disposed.

FIG. 6A is a diagram for explaining a regular reflection angle and a regular reflection direction.

FIG. 6B is a diagram for explaining a small reflection angle relative to the regular reflection angle, and a small-angle reflection direction relative to the regular reflection direction.

FIG. 6C is a diagram for explaining a large reflection angle relative to the regular reflection angle, and a large-angle reflection direction relative to the regular reflection direction.

FIG. 7A is a diagram for explaining surface regular reflection light.

FIG. 7B is a diagram for explaining surface diffused reflection light.

FIG. 7C is a diagram for explaining internal diffused reflection light.

FIG. 8 is a diagram for explaining the results of measurement of the characteristics between the detection angle and the reflected light intensity obtained by a goniophotometer.

FIG. 9 is a diagram for explaining a light beam received by each of the photodetectors.

FIG. 10 is a diagram for explaining the measurement results of signal levels S1 and S2 for various brands of printing sheets.

FIG. 11 is a diagram for explaining the influences of the number of light-emitting parts on the contrast ratio of a speckle pattern.

FIG. 12 is a diagram for explaining the measurement results of the contrast ratio of a speckle pattern and the total amount of light when the number of light-emitting parts is changed, and when the amount of light of each light-emitting part is changed.

FIG. 13 is a diagram for explaining the light intensity distribution of a speckle pattern when the driving current of the light source is changed.

FIG. 14 is a diagram for explaining the effective light intensity distribution of a speckle pattern when the driving current of the light source is changed at high speed.

FIG. 15 is a diagram for explaining a modification of the optical sensor.

FIG. 16 is a diagram for explaining another modification of the optical sensor.

FIG. 17 is a diagram for explaining a surface emitting laser array in which the intervals of light-emitting parts are not equal intervals.

FIG. 18 is a diagram for explaining the light intensity distribution of a speckle pattern when the intervals of light-emitting parts are at equal intervals.

FIG. 19 is a diagram for explaining the light intensity distribution of a speckle pattern when the intervals of light-emitting parts are not at equal intervals.

FIG. 20 is a diagram for explaining another modification of the optical sensor.

FIG. 21 is a diagram for explaining another modification of the optical sensor.

FIG. 22 is a diagram for explaining another modification of the optical sensor.

FIG. 23 is a diagram for explaining another modification of the optical sensor.

FIG. 24 is a diagram for explaining another modification of the optical sensor.

FIG. 25 is a diagram for explaining another modification of the optical sensor.

FIG. 26 is a diagram for explaining the relationship between S4/S1 and S3/S2 and the brands of printing sheets.

FIG. 27A and FIG. 27B are diagrams for explaining the influences of disturbance light.

FIG. 28 is a diagram for explaining another modification of the optical sensor.

FIG. 29 is a diagram for explaining another modification of the optical sensor.

FIG. 30 is a diagram for explaining the measurement results of the thickness and the signal level S1.

FIG. 31 is a diagram for explaining the measurement results of the density and the signal level S1.

### DETAILED DESCRIPTION OF THE PREFERRED EMBODIMENTS

A description will be given of embodiments of the present disclosure with reference to the accompanying drawings.

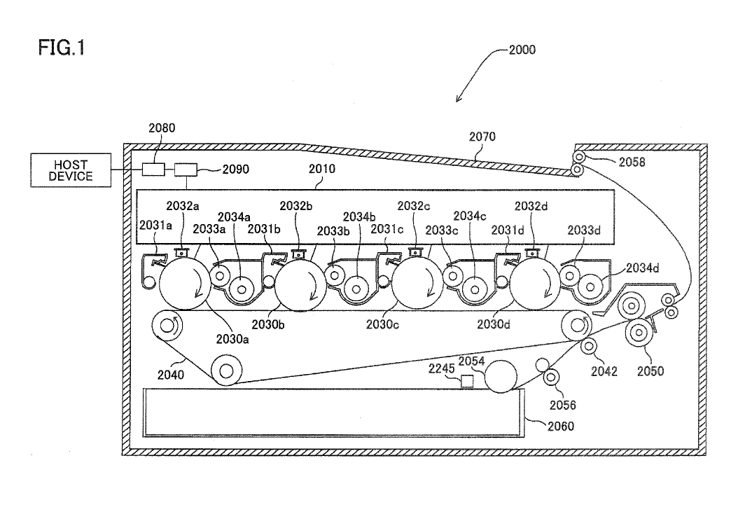

An embodiment of the present disclosure will be described with reference to FIGS. 1 to 14. FIG. 1 shows the outline composition of a color printer 2000 according to the present embodiment.

The color printer 2000 of the present embodiment is a tandem-type multi-color printer in which images of four colors (black, cyan, magenta, yellow) are superimposed so that a full-color image is formed. This color printer generally includes an optical scanning device 2010, four photoconductor drums 2030a, 2030b, 2030c, 2030d, four cleaning units 2031a, 2031b, 2031c, 2031d, four charging units 2032a, 2032b, 2032c, 2032d, four developing rollers 2033a, 2033b, 2033c, 2033d, four drive rollers 2034a, 2034b, 2034c, 2034d, a transfer belt 2040, a transfer roller 2042, a fixing unit 2050, a feed roller 2054, a delivery roller 2058, a sheet feed tray 2060, a sheet output tray 2070, a communication controller 2080, an optical sensor 2245, and a printer controller 2090.

The printer controller 2090 controls the above components of the color printer. The communication controller 2080 controls the bidirectional communication with a host device (for example, a personal computer) through a network.

The printer controller 2090 generally includes a CPU, a ROM, a RAM, an amplifier, and an A/D converter circuit. In the ROM, a computer-executable program described by decipherable control codes for the CPU, and various data used when the program is executed by the CPU are stored. The RAM is a memory which provides a working space used by the CPU when the program is executed. The AD converter circuit converts analog data into digital data. The printer controller 2090 controls the respective component parts in accordance with instructions received from the host device, and transfers the image information received from the host device to the optical scanning device 2010.

The photoconductor drum 2030a, the charging unit 2032a, the developing roller 2033a, and the cleaning unit 2031a are used as a group, and constitute a K (black) image formation station (K station) which forms an image of black. The photoconductor drum 2030b, the charging unit 2032b, the developing roller 2033b, and the cleaning unit 2031b are used as a group, and constitute a C (cyan) image formation station (C station) which forms an image of cyan. The photoconductor drum 2030c, the charging unit 2032c, the developing roller 2033c, and the cleaning unit 2031c are used as a group, and constitute an M image formation station (M station) which forms an image of magenta. The photoconductor drum 2030d, the charging unit 2032d, the developing roller 2033d, and the cleaning unit 2031d are used as a group, and constitute a Y image formation station (Y station) which forms an image of yellow.

Each of the photoconductor drums has a surface in which a photosensitive layer is formed. That is, the surface of each photoconductor drum is an optically scanned surface for image formation. Each photoconductor drum is rotated by a non-illustrated rotating mechanism in a direction indicated by the arrow in FIG. 1.

Each charging unit electrically charges the surface of the corresponding photoconductor drum in a uniform manner, respectively.

The optical scanning device 2010 optically scans the charged surface of the corresponding photoconductor drum by a light beam of the corresponding color modulated in accordance with the multicolor image information (black image information, cyan image information, magenta image information, yellow image information) received from the printer controller 2090, respectively. Thereby, the latent image corresponding to the relevant image information is formed on the surface of each photoconductor drum, respectively. The latent image formed is moved in the direction to the corresponding developing roller by the rotation of the photoconductor drum.

The toner from a corresponding toner cartridge (not illustrated) is supplied to the surface of each developing roller uniformly by the rotation of the photoconductor drum. If the toner of the surface of each developing roller touches the surface of the corresponding photoconductor drum, it is transferred only to the portion of the surface radiated by the light. Namely, each developing roller causes the toner to adhere to the latent image formed on the surface of the corresponding photoconductor drum, so that a toner image is developed. The image (toner image) to which the toner adheres is moved in the direction to the transfer belt 2040 by the rotation of the photoconductor drum.

The respective toner images of yellow, magenta, cyan, and black are transferred in predetermined timing sequentially, and they are superimposed on the transfer belt 2040, so that a full-color image is formed. Printing sheets are stored in the sheet feed tray 2060. The feed roller 2054 is disposed near the sheet feed tray 2060, and takes out a printing sheet from the sheet feed tray 2060 at a time. The printing sheet is transported to the gap between the transfer belt 2040 and the transfer roller 2042 in predetermined timing. Thereby, the toner image on the transfer belt 2040 is transferred to the printing sheet. The printing sheet to which the toner image is transferred is sent to the fixing unit 2050.

Using the fixing unit 2050, heat and pressure are applied to the printing sheet and the toner image is fixed to the printing sheet. The printing sheet to which the image is fixed is sent to the sheet output tray 2070 via the delivery roller 2058 and stacked on the sheet output tray 2070.

Each cleaning unit removes the toner (residual toner) remaining on the surface of the corresponding photoconductor drum. The surface of the photoconductor drum from which the residual toner is removed is returned back to the position which faces the corresponding charging unit.

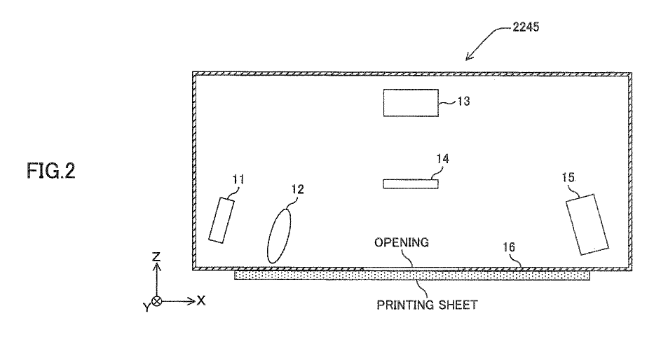

In the present embodiment, the optical sensor 2245 is used for identifying a brand of a printing sheet accommodated in the sheet feed tray 2060. This optical sensor 2245 includes a light source 11, a collimating lens 12, two photodetectors 13 and 15, a polarizing filter 14, and a black box 16 in which these parts are housed, as shown in FIG. 2.

The black box 16 is a metallic box member. For example, this box member is made of aluminum, and in order to reduce the influences of disturbance light and stray light, the surface of the box member is finished by black alumite processing (or anodized aluminum coating). As shown in FIG. 2, the black box 16 has an opening in a bottom surface of the box member which is exposed to a printing sheet accommodated in the sheet feed tray 2060 via the opening, and a light beam emitted from the light source 11 is incident on a surface of the printing sheet through the opening.

In the following, it is assumed that a Z-axis orientation in an XYZ three-dimensional rectangular coordinate system represents a direction perpendicular to a surface of a printing sheet, and an XY plane in the XYZ three-dimensional rectangular coordinate system represents a surface parallel to the surface of the printing sheet. It is assumed that the optical sensor 2245 is disposed on the +Z side of a printing sheet in the sheet feed tray 2060.

The light source 11 includes plural light-emitting parts formed on one substrate. Each light-emitting part is formed into a vertical cavity surface emitting laser (VCSEL). Specifically, the light source 11 includes a vertical cavity surface emitting laser array (VCSEL array) which contains plural light-emitting parts (or VCSELs) arranged in a two-dimensional formation.

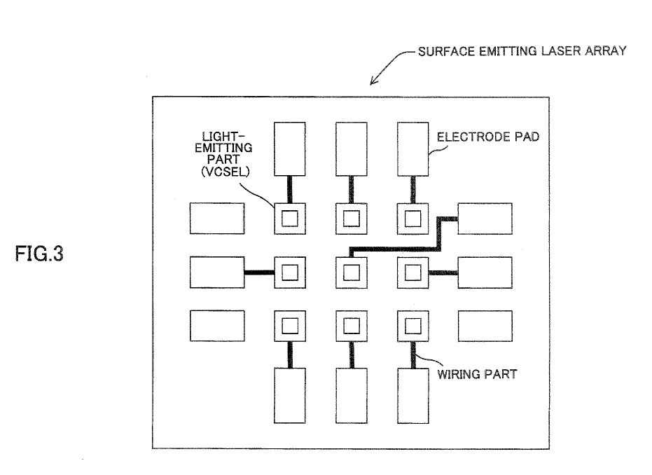

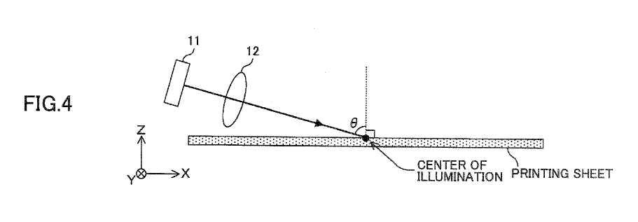

FIG. 3 shows a vertical cavity surface emitting laser array (VCSEL array) included in the light source 11 of the optical sensor 2245. As shown in FIG. 3, a two-dimensional array in which nine light-emitting parts (VCSELS) are arrayed is provided in the light source 11. This light source 11 is disposed so that each of the light-emitting parts emits a linearly polarized light beam by s-polarization which is incident on the printing sheet. In the present embodiment, an incident angle θ (see FIG. 4) of a light beam from the light source 11 to the printing sheet surface is equal to 80 degrees.

The collimating lens 12 is disposed in an optical path of light beams emitted by the light source 11 to convert the light beams into collimated light beams (which are generally parallel to each other). The collimated light beams from the collimating lens 12 pass through the opening of the black box 16 and illuminate a printing sheet beneath the bottom of the black box 16. In the following, the center of an illuminated area on the surface of the printing sheet will be referred to as the center of illumination, and each of the light beams from the collimating lens 12 will be referred to as an emission light beam.

Generally, when light is incident to the interface plane of a medium, the plane containing the incident light and a normal to the interface plane at the point of incidence is called the plane of incidence. Strictly speaking, in a case in which the incident light includes plural light beams, the plane of incidence exists for each of the light beams. However, in the following, for the sake of convenience, it is assumed that the plane of incidence of a light beam which is incident on the center of illumination is called the plane of incidence on the printing sheet. Namely, it is assumed that the plane of incidence on the printing sheet contains the center of illumination and is parallel to the XZ plane in the XYZ three-dimensional rectangular coordinate system.

The polarizing filter 14 is disposed on the +Z side of the center of illumination. This polarizing filter 14 is a polarizing filter which transmits the p-polarized light and cuts off the s-polarized light. Alternatively, the polarizing filter 14 may be replaced with a polarizing beam splitter having equivalent functions.

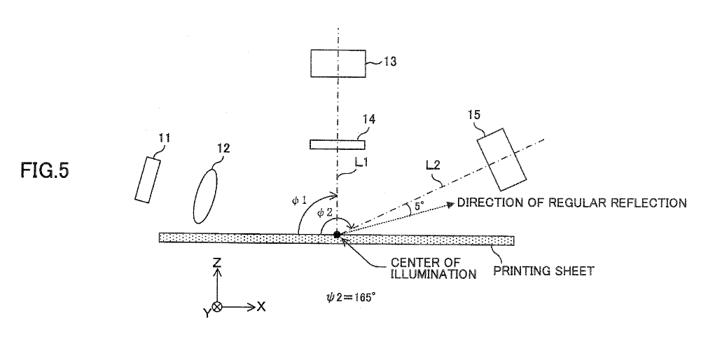

The photodetector 13 is disposed on the +Z side of the polarizing filter 14. In the present embodiment, as shown in FIG. 5, a line L1 is drawn to connect the center of illumination, the center of the polarizing filter 14 and the center of photodetector 13, and an angle φ1 (see FIG. 5) which the line L1 makes with the surface of the printing sheet is equal to 90 degrees. Namely, the line L1 is equivalent to a normal to the surface of the printing sheet at the center of illumination.

The photodetector 15 is disposed on the +X side of the center of illumination with respect to the X-axis orientation. In the present embodiment, a line L2 is drawn to connect the center of illumination and the center of the photodetector 15, and an angle φ2 (see FIG. 5) which the line L2 makes with the surface of the printing sheet is equal to, for example, 165 degrees.

On the other hand, the angle which the direction of regular reflection makes with the surface of the printing sheet is equal to, for examples, 170 degrees. In this case, the angle which the line L2 makes with the direction of regular reflection is equal to, for example, 5 degrees.

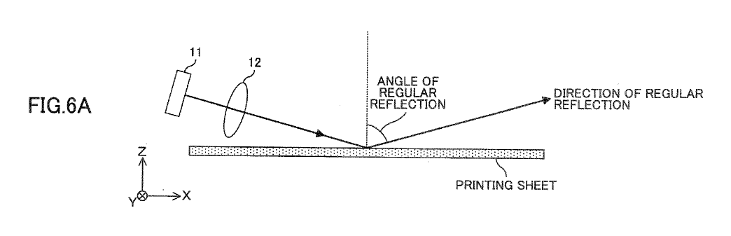

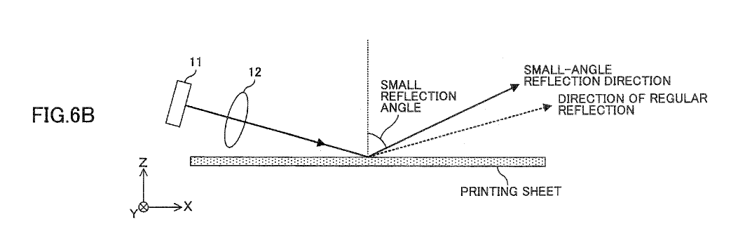

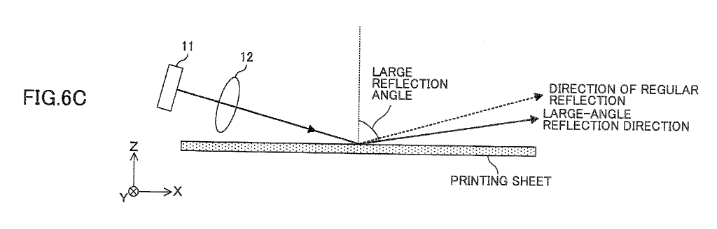

In the following, an angle of reflection smaller than the angle of regular reflection (FIG. 6A) is called a small reflection angle (FIG. 6B), and a direction of the small reflection angle is called a small-angle reflection direction (FIG. 6B). On the other hand, an angle of reflection larger than the angle of regular reflection (FIG. 6A) is called a large reflection angle (FIG. 6C), and a direction of the large reflection angle is called a large-angle reflection direction (FIG. 6C).

In the present embodiment, the photodetector 15 is disposed in the optical path of the light reflected by the small reflection angle.

In the present embodiment, the center of the light source 11, the center of illumination, the center of the polarizing filter 14, the center of the photodetector 13, and the center of the photodetector 15 substantially lie in the same plane.

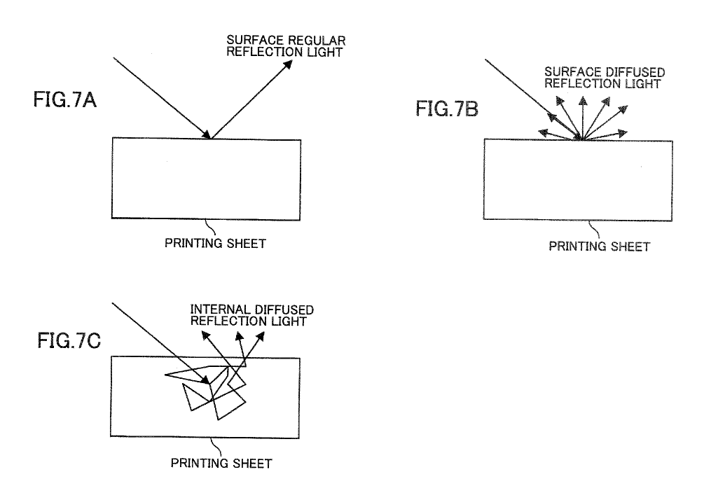

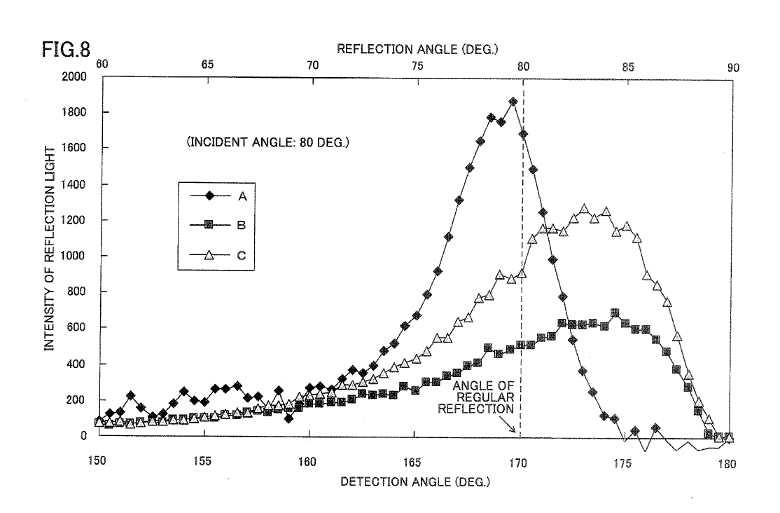

It is conceivable that the reflection light from the printing sheet when illuminating the printing sheet is divided into the reflection light reflected on the surface of the printing sheet, and the reflection light internally diffuse reflected inside the surface of the printing sheet. In the following, for the sake of convenience, the reflection light internally diffuse reflected inside the surface of the printing sheet is called internal diffused reflection light (see FIG. 7C). Further, it is conceivable that the reflection light reflected on the surface of the printing sheet is divided into the reflection light which is regularly reflected on the surface of the printing sheet, and the reflection light which is diffuse reflected on the surface of the printing sheet. In the following, for the sake of convenience, the reflection light which is regularly reflected on the surface of the printing sheet is called surface regular reflection light (see FIG. 7A), and the reflection light which is diffuse reflected on the surface of the printing sheet is called surface diffused reflection light (see FIG. 7B).

A surface of a printing sheet generally includes flat-surface portions and slope portions, and the smoothness of the printing sheet surface is determined by the ratio of the flat-surface portions to the slope portions. The light reflected in the flat-surface portions is turned into the surface regular reflection light, and the light reflected by the slope portions is turned into the surface diffused reflection light. The surface diffused reflection light is considered as containing reflection light beams which are fully scattered and have isotropic reflection directions. As the smoothness of the printing sheet surface increases, the amount of light of the surface regular reflection light increases.

In a case of a plain sheet in which no coating is applied to the surface thereof (the smoothness of which usually ranges from 10 sec. to 120 sec.), there is almost no flat-surface portion, and the ratio that the slope portions occupy is large. For this reason, the light reflected in the direction of regular reflection includes the surface regular reflection light and the surface diffused reflection light which are present in a mixed manner.

A goniophotometer is a device which measures the light reflected from an object at different angles. In the present embodiment, the goniophotometer is arranged to measure the detection-angle dependent characteristics of the intensity of reflection light reflected on a printing sheet with the incident angle being fixed. FIG. 8 shows the results of measurement of the characteristics between the detection angle and the reflected light intensity for three kinds of printing sheets (A, B, C) obtained by the goniophotometer. In this example, the incident angle is fixed to 80 degrees. In FIG. 8, the horizontal axis represents the detection angle (in degrees), and the reference plane of the reflection angle is the same as the above-described angle φ2 (FIG. 5). A printing sheet A is a coated sheet whose smoothness is 5200 sec., a printing sheet B is a plain sheet whose smoothness is 40 sec., and a printing C is a plain sheet whose smoothness is 120 sec. For the sake of convenience of description, the value of the reflection angle into which the detection angle is converted is also illustrated in FIG. 8.

As shown in FIG. 8, in the case of the coated sheet A, when the detection direction is almost the same as the direction of regular reflection, a peak of the reflection light intensity is present. However, in the case of the plain sheets B and C, when the detection direction is shifted by about 5 degrees from the direction of regular reflection, a peak of the reflection light intensity is present. It can be understood that the results of measurement of FIG. 8 are based on the micro facet theory and the Fresnel equations. In the micro facet theory, it is assumed that the surface irregularities are the microscopic slope portions. According to the Fresnel equations, as the incident angle increase, the reflection coefficient increases.

In the example shown in FIG. 8, when the detection angle is around 172 degrees (or when the reflection angle is around 82 degrees), the reflection light intensities of the three printing sheets (A, B, C) are almost the same. If the signal levels in the optical sensor for different kinds of printing sheets are almost the same in this manner, it is difficult to identify the kind of each sheet accurately.

The level of accuracy of measurement of the detection angle of the goniophotometer described above is 0.1 degrees. However, in the optical sensor 2245, the optical path length of the reflection light to the photodetector 15 is small, and the range of the incident angle of the light received by the photodetector 15 (which will be called a reception angle range) is relatively large (several degrees).

For example, when the reception angle range is ±5 degrees, even if the photodetector 15 is disposed in the direction of regular reflection (which is the direction of the reflection angle of about 80 degrees in FIG. 8), the reflection angle of the light received by the photodetector 15 is in a range of 75-85 degrees. In this case, the reflection light the reflection angle of which is about 82 degrees at which the level of accuracy for identifying the sheet kind is at the minimum is also received by the photodetector 15. In the example of FIG. 8, if the detection angle exceeds 172 degrees, the reflection light intensity in the printing sheet A is steeply lowered. If the reflection light intensity for the detection angle ranging from 165 degrees to 175 degrees (or for the reflection angle ranging from 75 degrees to 85 degrees) is integrated, the differences between the integral values of the three printing sheets (A, B, C) are smallest. Hence, if the photodetector 15 is disposed in the direction of regular reflection (or the direction of the reflection angle of BO degrees), the level of accuracy for identifying the sheet kind falls.

In the present embodiment, the angle φ2 (FIG. 5) which the line L2 connecting the center of illumination and the center of the photodetector 15 makes with the surface of the printing sheet is equal to 165 degrees (which is equivalent to the reflection angle of 75 degrees), in order to prevent the receiving of the reflection light the detection angle of which is around 172 degrees when the reception angle range of the photodetector 15 is taken into consideration.

In the example of FIG. 8, when the detection angle is less than 170 degrees, the reflection light intensity for each of the three printing sheets (A, B, C) increases as the detection angle increases. If the reflection light intensity in the reception angle range is integrated, the differences between the integral values of the three kinds of the printing sheets (A, B, C) are comparatively large. Therefore, the level of accuracy for identifying the sheet kind can be improved.

However, as is apparent from FIG. 8, if the detection angle is too small, the reflection light intensity is too small. In this case, the amount of light received by the photodetector 15 falls and the S/N is lowered. Hence, in the present embodiment, the detection angle of around 160 degrees (or the reflection angle of around 70 degrees) is taken as a lower limit of the detection angle. In other words, the upper limit of the detection angle is equal to 170 degrees and the lower limit of the detection angle is equal to 160 degrees. Specifically, in the present embodiment, the angle φ2 is set to 165 degrees so that the reflection light the detection angle of which is in a range of 160-170 degrees can be received by the photodetector 15.

In a case of a commonly used printing sheet, multiple scattering of the reflection light takes place in the internal fibers of the sheet, and the reflection light diffuse reflected inside the surface of the printing sheet is turned into only the diffused reflection light. In the following, the reflection light from the inside of the surface of the printing sheet is the internal diffused reflection light (FIG. 7C). Similar to the surface diffused reflection light, the internal diffused reflection light is considered as containing reflection light beams which are fully scattered and have isotropic reflection directions.

The polarizing directions of the surface regular reflection light and the surface diffused reflection light are the same as the polarizing direction of the incident light. In order to allow the polarizing direction to be rotated on a surface of a printing sheet, the incident light must be reflected on a slope surface inclined in the direction of the rotation relative to the incident direction. In the present embodiment, the center of the light source, the center of illumination, and the center of each of the photodetectors lie in the same plane, and the reflection light whose polarizing direction is rotated on the surface of the printing sheet does not enter each of the photodetectors.

On the other hand, the polarizing direction of the internal diffused reflection light is rotated relative to the polarizing direction of the incident light. It appears that the internal diffused reflection light penetrates the inside of the fibers and is subjected to multiple scattering, so that the polarizing direction thereof is rotated.

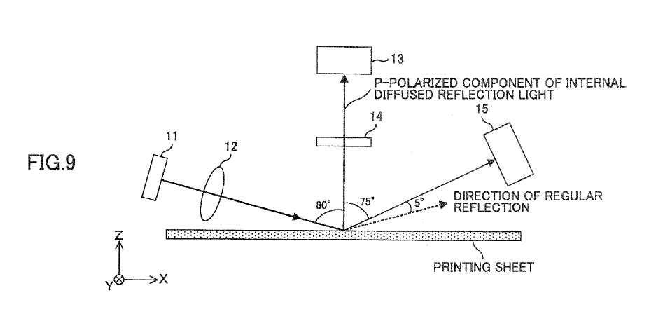

The surface diffused reflection light and the internal diffused reflection light are incident on the polarizing filter 14. The polarizing direction of the surface diffused reflection light is the s-polarization (which is the same as the polarizing direction of the incident light), and the surface diffused reflection light is cut off by the polarizing filter 14. On the other hand, the polarizing direction of the internal diffused reflection light is rotated relative to the polarizing direction of the incident light, and the p-polarized component contained in the internal diffused reflection light penetrates the polarizing filter 14. Hence, the p-polarized component contained in the internal diffused reflection light is received by the photodetector 13 (see FIG. 9).

In the following, the p-polarized component contained in the internal diffused reflection light is called p-polarized component of the internal diffused reflection light, and the s-polarized component contained in the internal diffused reflection light is called s-polarized component of the internal diffused reflection light.

The inventors of the present disclosure have confirmed that the amount of light of the p-polarized component of the internal diffused reflection light shows a correlation with the thickness and density of a printing sheet. This is because the amount of light of the p-polarized component depends on the length of the optical path of the reflection light passing through the fibers inside the printing sheet.

The surface regular reflection light and a fractional part of the surface diffused reflection light and the internal diffused reflection light are incident on the photodetector 15.

Each of the photodetector 13 and the photodetector 15 outputs an electric signal (or a photoelectric conversion signal) proportional to the amount of light received at the corresponding photodetector, to the printer controller 2090, respectively. In the following, S1 denotes a signal level of the output signal of the photodetector 13, and S2 denotes a signal level of the output signal of the photodetector 15 when the printing sheet is irradiated by the light from the light source 11.

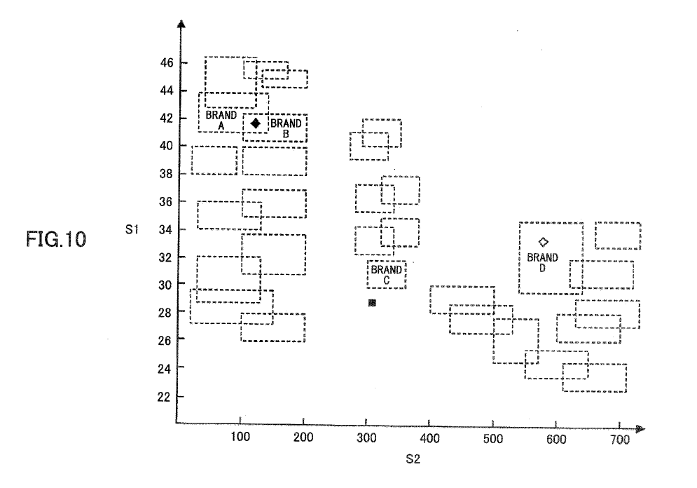

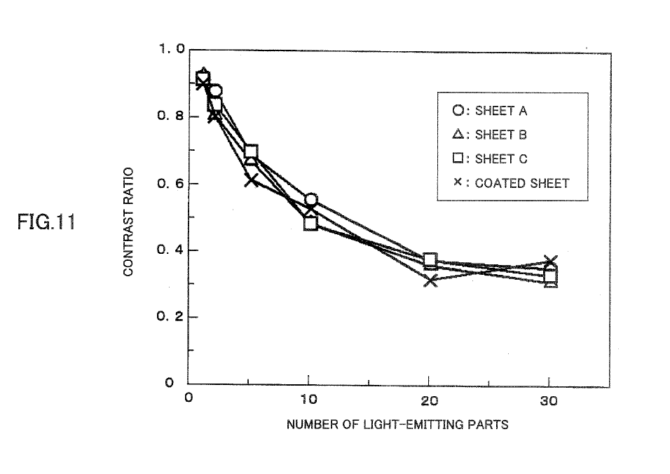

In the present embodiment, with respect to plural brands of printing sheets which can be used in the color printer 2000, the values of S1 and S2 are measured in advance for each brand in a pre-shipment process, such as an adjustment process, and the results of the measurement are stored in the ROM of the printer controller 2090 as a printing sheet distinction table. FIG. 10 shows the measurement values of the signal levels S1 and S2 for 30 brands of printing sheets which are currently available in the domestic market. In FIG. 10, each of the rectangles indicated by dotted lines shows a range of variations of the signal level values for the same brand. For example, when the detection values of S1 and S2 obtained by the optical sensor 2245 match the measurement values indicated by ⋄ in FIG. 10, the kind of a printing sheet in the color printer 200 is identified as being the brand D. If the detection values of S1 and S2 obtained by the optical sensor 2245 match the measurement values indicated by ▪ in FIG. 10, the kind of the printing sheet in the color printer 200 is identified as being nearest to the brand C.

If the detection values of S1 and S2 obtained by the optical sensor 2245 match the measurement values indicated by ♦ in FIG. 10, the kind of the printing sheet in the color printer 200 is identified as being either the brand A or the brand B. For example, in this case, a difference between the average measurement values of the brand A and the detection values and a difference between the average measurement values of the brand B and the detection values are computed. The kind of the printing sheet in the color printer 200 is identified as being the brand with which the computed difference is the smaller one. Alternatively, the kind of the printing sheet in the color printer 200 may be identified as follows. Assuming that the kind of the printing sheet is the brand A, variations including the detection values are computed. Assuming that the kind of the printing sheet is the brand B, variations including the detection values are computed. Then, the kind of the printing sheet in the color printer 200 is identified as being the brand with which the computed variations are the smaller one.

Conventionally, the degree of gloss of the sheet surface is detected based on the amount of light of the regular reflection light, the smoothness of the sheet surface is detected based on the ratio of the amount of light of the regular reflection light to the amount of light of the diffused reflection light, and the kind of the printing sheet is identified from the degree of gloss and the smoothness. In contrast, in the present embodiment, the information containing not only the degree of gloss and the smoothness of the surface of the printing sheet but the thickness and the density of the printing sheet is detected from the reflection light, and the kind of the printing sheet can be identified more finely than in the conventional identifying method.

For example, it is difficult to distinguish between a plain sheet and a mat coated sheet based on only the information of the sheet surface used by the conventional identifying method. However, in the present embodiment, the information of the sheet surface in addition to the information of the inside of the printing sheet is used for identifying the kind of the printing sheet, and it is possible to not only distinguish between a plain sheet and a mat coated sheet but also distinguish plural brands of a plain sheet and plural brands of a matte coated sheet.

In other words, in the present embodiment, it is possible to identify a brand of a sheet from among plural brands of printing sheets in which at least one of the degree of gloss, the smoothness, the thickness and the density differs.

In the present embodiment, with respect to plural brands of printing sheets which can be used in the color printer 2000, the optimal development conditions and transfer conditions for the respective stations of the color printer 2000 are determined in advance for each brand in a pre-shipment process, such as an adjustment process, and the determination results are stored in the ROM of the printer controller 2090 as a development/transfer table.

When the power supply to the color printer 2000 is turned on or when one or more printing sheets are supplied to the sheet feed tray 2060, the printer controller 2090 is activated to perform a sheet kind distinction process of the printing sheets. This sheet kind distinction process performed by the printer controller 2090 includes the following steps (1)-(4).

(1) Control the plural light-emitting parts of the optical sensor 2245 to emit light beams simultaneously.

(2) Compute the values of S1 and S2 based on the respective output signals of the photodetector 13 and the photodetector 15.

(3) Identify the brand of the printing sheet by accessing the printing sheet distinction table in the ROM based on the computed values of S1 and S2.

(4) Store the identified brand of the printing sheet in the RAM, and terminate the sheet kind distinction process.

If a print job request from a user is received, the printer controller 2090 reads out the brand of the printing sheet stored in the RAM and determines the optimal development conditions and transfer conditions for the brand of the printing sheet based on the development/transfer table stored in the ROM.

Subsequently, the printer controller 2090 controls the developing devices of the respective stations and the transfer device of the color printer 2000 according to the optimal development conditions and transfer conditions. For example, a transfer voltage and a toner amount are controlled at this time. Accordingly, an image with high quality is formed on the printing sheet.

Generally, the diffused reflection light from a printing sheet contains: (A) surface diffused reflection light; (B) s-polarized component of internal diffused reflection light; and (C) p-polarized component of internal diffused reflection light.

In the device using the conventional sensor, a kind of a printing sheet is identified from among two or three kinds based on the amount of light of the diffused reflection light (A+B+C). In contrast, in the present embodiment, a kind of a printing sheet is identified from among ten or more kinds based on the amount of light of the p-polarized component of internal diffused reflection light (C). Namely, the sheet kind distinction in the present embodiment is performed in a manner that is much finer than that in the conventional device.

When the emission light is s-polarized, the percentage of the amount of light of p-polarized component of the internal diffused reflection light (C) to the amount of light of the diffused reflection light (A+B+C) is about 40% at the most. An inexpensive polarizing filter which is usually used in the existing optical sensor has a low transmissivity and the amount of emission light may be decreased to about 80% due to the use of such a polarizing filter. Thus, the p-polarized component of internal diffused reflection light is attenuated when separated by the polarizing filter, and the resulting amount of light may be substantially 30%.

Therefore, the amount of light of the p-polarized component of internal diffused reflection light is decreased to about 30% of the amount of light of the diffused reflection light (A+B+C), and the amount of emission light which is 3.3 times as large as the amount of emission light in the conventional device is required for the present embodiment. In order to perform finer sheet kind distinction than that of the conventional device, it is necessary to increase the amount of emission light in the present embodiment. If an expensive photodetector with high resolution is used, the finer sheet kind distinction may be performed with a comparatively small amount of emission light. However, the cost will be increased with the use of such a photodetector.

In a case where a non-polarized light source, such as an LED (light-emitting diode), is used, it is necessary to make linear polarization (s-polarization) of emission light from the LED (non-polarized light source) by passing the emission light through a polarizing filter before irradiation, in order to irradiate the surface of a printing sheet by an s-polarized light beam. If the inexpensive polarizing filter described above is used in this case, the amount of light to irradiate the printing sheet surface is decreased to about 40% of the amount of emission light from the LED (=50% (the removal of the p-polarized component)×80% (the attenuation by the polarizing filter)).

Therefore, in the case where the LED is used, the amount of emission light rather larger than that in the conventional device is required. However, the amount of emission light of the LED according to the related art is on the order of some milliwatts (typically, 1 mW) and it is practically impossible to obtain the required amount of emission light (at least 40 mW) for the present embodiment from the LED.

On the other hand, in a case of a surface emitting laser array, the required amount of emission light can be easily obtained by turning on plural light-emitting parts simultaneously. In order to detect the p-polarized component of internal diffused reflection light with a sufficient level of accuracy, it is preferred to satisfy the following two light-receiving conditions (1) and (2).

(1) The p-polarized component of internal diffused reflection light in a direction in which at least the surface regular reflection light is contained is not to be detected.

Actually, it is difficult to convert the emission light into the s-polarized light component only and the reflected light on the surface may contain the p-polarized light component. For this reason, in the direction in which the surface regular reflection light is contained, the percentage of the p-polarized component which is initially contained in the emission light and reflected on the surface is larger than that of the p-polarized component of internal diffused reflection light. Hence, if the polarizing filter 14 and the photodetector 13 are disposed in the direction in which the surface regular reflection light is contained, the amount of the reflected light containing the information inside the printing sheet cannot be detected with a sufficient level of accuracy.

It is conceivable to use a polarizing filter having a high extinction ratio, in order to convert the emission light into the s-polarized light component only. However, in this case, the cost will be increased.

(2) The p-polarized component of internal diffused reflection light in a direction of a normal to the center of illumination on a surface of a printing sheet is to be detected.

The internal diffused reflection light can be considered as uniformly diffused reflection light, the amount of reflected light in the detection direction can be approximated by Lambert's emission law, and the amount of the reflected light in the direction of the normal to the center of illumination is the maximum. Therefore, in the present embodiment, the polarizing filter 14 and the photodetector 13 are disposed in the direction of the normal to the center of illumination, and the S/N is sufficiently high and the level of accuracy is also sufficiently high.

Next, a method for prevention of a speckle pattern will be described.

In a sensor which detects a surface state of a printing sheet from an amount of reflected light, it is preferred to use a semiconductor laser as a light source in order to increase the S/N. However, the coherent light emitted from the semiconductor laser in this case is irregularly reflected on a rough surface, such as a surface of a printing sheet, and a speckle pattern takes place due to mutual interference of the irregularly reflected light beams.

The speckle pattern changes depending on the location of light irradiation, which may cause variations in the amount of light received by the photodetector and may cause lowering of the level of accuracy. Therefore, the LED has been usually used in the conventional device as the light source.

The inventors have examined the relationship between the number of light-emitting parts and the contrast ratio of a speckle pattern, by using a vertical cavity surface emitting laser array (VCSEL array) in which plural light-emitting parts are arrayed in a two-dimensional formation as a light source (see FIG. 11). In this example, a normalized value of a difference between the maximum and the minimum of the observed intensity of the speckle pattern is defined as a contrast ratio of the speckle pattern. In the following, the contrast ratio of the speckle pattern will be simply called the contrast ratio.

Observation of the speckle pattern is performed using a beam profiler with respect to the Y-axis orientation (diffusion direction), and the contrast ratio is computed based on the observation results obtained by the beam profiler. As the test samples, three kinds of plain sheets (a plain sheet A, a plain sheet B and a plain sheet C) which have mutually different smoothness values and a coated sheet are used. The plain sheet A is a plain sheet having an Oken smoothness value of 33 seconds, the plain sheet B is a plain sheet having an Oken smoothness value of 50 seconds, and the plain sheet C is a plain sheet having an Oken smoothness value of 100 seconds.

As is apparent from FIG. 11, there is a tendency that the contrast ratio decreases as the number of light-emitting parts increases. It can be understood that the tendency does not depend on the sheet kind.

The inventors have conducted an experiment for confirming that the effect of reducing the contrast ratio can be obtained by the increase in the number of light-emitting parts, rather than the increase in the total amount of light.

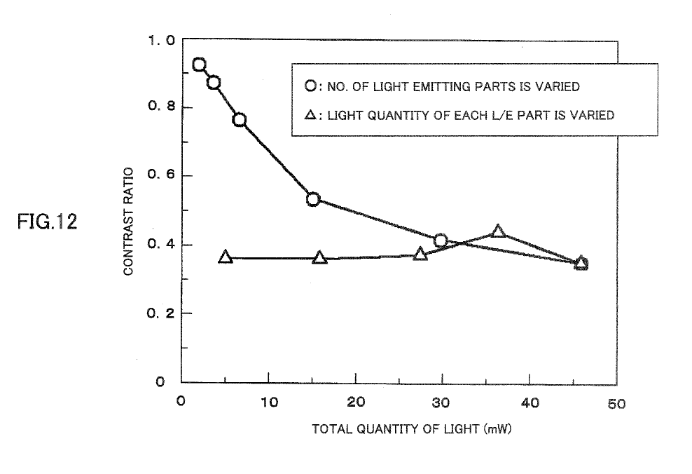

FIG. 12 shows the relationship between the contrast ratio and the total amount of light when the amount of light of each light-emitting part is maintained constant (1.66 mW) and the number of light-emitting parts is varied and when the number of light-emitting parts is fixed (30 pieces) and the amount of light of each light-emitting part is varied.

In the case where the number of light-emitting parts is fixed and the amount of light of each light-emitting part is changed, the contrast ratio is constant and does not depend on the total amount of light. In contrast, in the case where the amount of light of each light-emitting part is fixed and the number of light-emitting parts is changed, the contrast ratio is large when the number of light-emitting parts is small, and the contrast ratio decreases as the number of light-emitting parts increases. As is apparent from FIG. 12, it can be understood that the effect of reducing the contrast ratio can be obtained by the increase in the number of light-emitting parts, rather than the increase in the total amount of light.

Furthermore, the inventors have confirmed that occurrence of a speckle pattern can be prevented by changing the wavelength of light emitted from the light source in time.

In a case of a surface emitting laser (VCSEL), the wavelength of emission light can be controlled by adjusting the driving current. If the driving current is varied, the refractive index changes due to changes in the temperature inside the surface emitting laser, and the effective cavity length of the laser changes.

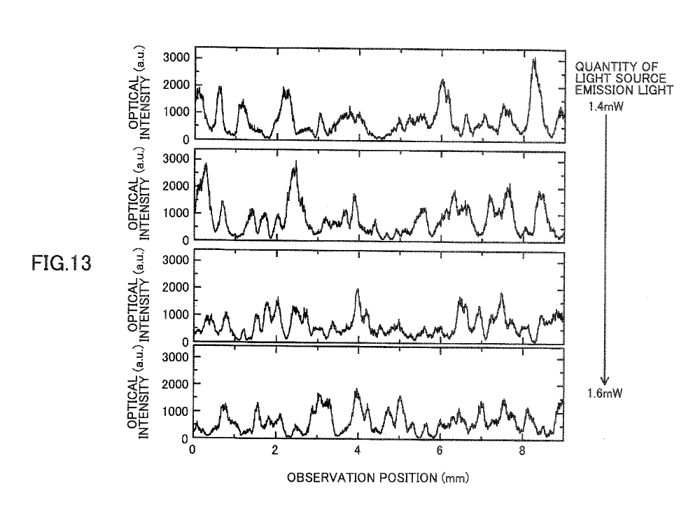

FIG. 13 shows the light intensity distribution of a speckle pattern when the driving current of the light source 11 is changed. The light intensity distribution is obtained by the results of observation of the speckle pattern by a beam profiler when the driving current of the light source 11 is changed to vary the amount of emission light in a range of 1.4 mW to 1.6 mW. As is apparent from FIG. 13, it can be understood that the light intensity distribution is changed due to the changes of the driving current, or due to the changes of the wavelength of the light emitted from the light source 11.

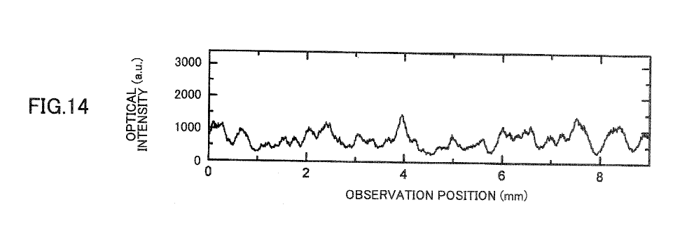

FIG. 14 shows the effective light intensity distribution of a speckle pattern when the driving current is changed at high speed. This light intensity distribution is equivalent to the average of the light intensity distributions for the driving current values as shown in FIG. 13, and the variations of light intensity are reduced. The contrast ratio when the driving current is changed at high speed is equivalent to 0.72, and it is reduced from the contrast ratio of 0.96 when the driving current is fixed.

It can be understood that if the wavelength of emission light is varied in time, occurrence of a speckle pattern can be prevented. Hence, if the driving current the current value of which changes in time, for example, in a triangular waveform, is used as the driving current of the surface emitting laser, the contrast ratio can be reduced.

In the present embodiment, the light source 11 of the optical sensor 2245 includes a surface emitting laser array in which nine light-emitting parts are arrayed in a two-dimensional formation and the CPU of the printer controller 2090 supplies a driving current in a triangular waveform to the surface emitting laser array. Thereby, occurrence of a speckle pattern is prevented and detection of the amount of reflected light can be performed with a sufficient level of accuracy. Further, the level of accuracy for identifying the kind of the printing sheet can be increased.

In the surface property identifying device disclosed in Japanese Laid-Open Patent Publication No. 2002-340518 and the printing device disclosed in Japanese Laid-Open Patent Publication No. 2003-292170, the surface of the printing material may be damaged and the surface characteristic of the printing material may be changed by itself.

The printing material which can be identified by the printing material discriminating device disclosed in Japanese Laid-Open Patent Publication No. 2005-156380 is limited to printing materials having different smoothness values. This device is unable to distinguish the printing materials having equal smoothness values and different thickness values.

The sheet material quality discriminating device disclosed in Japanese Laid-Open Patent Publication No. 10-160687 distinguishes the sheet material quality based on the amount of light of the regular reflection light. That is, the sheet quality of the sheet material is identified based on the amount of light of the regular reflection light solely without taking the inside of the sheet material into consideration.

In the image forming device disclosed in Japanese Laid-Open Patent Publication No. 2006-062842, the amount of light of the reflection light from a sheet is detected in each of two or more directions. Also in this case, the inside of the object is not taken into consideration, the degree of gloss is detected based on the ratio of the regular reflection light and the diffused reflection light, and the sheet kind is identified by the detected degree of gloss.

In the image forming device disclosed in Japanese Laid-Open Patent Publication No. 11-249353, the regular reflection light is divided into two polarized components, and each polarized component is detected. The smoothness of the surface of a printing sheet is determined based on the difference between the amounts of light of the polarized components, and the sheet kind is identified by the determined smoothness. Although the light polarization is used in this case, the amounts of light of the polarized components in the direction containing the regular reflection light are detected. The inside of the object is not taken into consideration.

Accordingly, in the sheet material quality discriminating device disclosed in Japanese Laid-Open Patent Publication No. 10-160687, and the image forming devices disclosed in Japanese Laid-Open Patent Publication No. 2006-062842 and Japanese Laid-Open Patent Publication No. 11-249353, only the difference between a non-coated sheet, a coated sheet and an OHP sheet can be distinguished, but the sheet kind distinction on a brand basis cannot be performed.

Conventionally, the distinction of a non-coated sheet, a coated sheet and an OHP sheet is performed, but the sheet kind distinction on a brand basis is impossible.

Furthermore, any of various sensors, other than a reflection type optical sensor, including a sensor to detect a thickness of a print medium using transmission light, ultrasonic waves, etc., a sensor to detect a resistance of a print medium, and a temperature sensor, may be separately attached in addition to the reflection type optical sensor in order to increase the level of accuracy of the sheet kind distinction. However, in such a case, the number of component parts is increased, the cost is increased and the size of the device is increased.

The method of identifying the kind of the printing sheet according to the present embodiment takes into consideration the amount of light of the internal diffused light which contains the information of the inside the printing sheet, which has not been used in the conventional method. In the present embodiment, the information of any of the degree of gloss (smoothness) of the printing sheet surface, and the thickness and density of the printing sheet can also be acquired. The kind of a printing sheet can be identified more finely than in the related art, without increasing the device cost and the size.

As described above, in the optical sensor 2245 of the present embodiment, the light source 11 and the collimating lens 12 constitute a light emission module of the present disclosure, the photodetector 15 constitutes a first photodetector module of the present disclosure, and the polarizing filter 14 and the photodetector 13 constitute a second photodetector module of the present disclosure.

As described above, the optical sensor 2245 of the present embodiment includes the light source 11, the collimating lens 12, the photodetector 13, the polarizing filter 14, the photodetector 15, the black box 16, etc.

The optical sensor 2245 of the present embodiment is arranged so that the incident angle of emission light on the printing sheet is set to 80 degrees, and a reflected light beam having a reflection angle from the normal toward the printing sheet surface in a range of 70 to 80 degrees is received by the photodetector 15. In this case, the photodetector 15 can output a signal carrying the information of the smoothness of the printing sheet with a sufficient level of accuracy. The photodetector 13 is disposed so that a large amount of light of the p-polarized component of internal diffused reflection light can be received. In this case, the reflection light from the inside of the printing sheet which has been difficult to separate by the conventional method can be separated with a high level of accuracy. The reflection light from the inside of the printing sheet carries the information of the internal state of the printing sheet.

The light source 11 includes the surface emitting laser array containing the plural light-emitting parts arrayed in a two-dimensional formation. In this case, it is not necessary to use a polarizing filter for converting emission light into a linearly polarized light beam. With the light source of the surface emitting laser array, adjustment for collimating the emission light into parallel light beams can be easily performed. It is possible to reduce the size and the cost of the optical sensor.

In the case of the surface emitting laser array, high-density integration of plural light-emitting parts is possible. With the use of the surface emitting laser array, all laser beams from the laser array can be concentrated in the vicinity of the optical axis of the collimating lens. It is possible to fix the incident angle of each laser beam to a predetermined angle and to convert the laser beams into parallel laser beams. Hence, a collimating optical system can be easily constructed.

The printer controller 2090 controls the light source 11 to turn on the light-emitting parts of the surface emitting laser array to emit light beams simultaneously. The amount of light of the p-polarized component of internal diffused reflection light can be increased, and the contrast ratio can be reduced. Further, the printer controller 2090 controls the light source 11 to change in time the wavelength of the light beam emitted from each of the light-emitting parts of the light source 11. For this reason, occurrence of a speckle pattern can be prevented.

The printer controller 2090 identifies the brand of a printing sheet based on the output signal of the photodetector 13 and the output signal of the photodetector 15. That is, the level, of accuracy of the sheet kind distinction can be increased to the level of the brand by considering the information of the internal state of the printing sheet.

The composition of the parts of the optical sensor 2245 of the present embodiment is simple and it is not necessary to use two or more kinds of sensors in combination. The size and the cost of the optical sensor can be reduced.

Hence, according to the optical sensor 2245 of the present embodiment, the brand of a printing sheet can be identified more finely than in the related art, without increasing the device cost and the size. The color printer 2000 of the present embodiment includes this optical sensor 2245 and can form an image with high quality without increasing the device cost and the size. Further, an inconvenience of performing setting operations manually and a printing error due to improper setting items can be avoided.

In printers and copiers which are commonly used in offices, a plain sheet is most frequently used as a printing sheet. In this case, the sensitivity of the photodetector of the optical sensor may be suited to the plain sheet. In the example of FIG. 8, even when the detection angle is larger than 172 degrees (where the reflection light intensity of the printing sheet A and the reflection light intensity of the printing sheet B are almost the same), the reflection light intensities of the printing sheet B and the printing sheet C (which are plain sheets) continue to increase as the detection angle increases. However, if the detection angle exceeds 178 degrees, the reflection light intensities of the printing sheet B and the printing sheet C are almost the same.

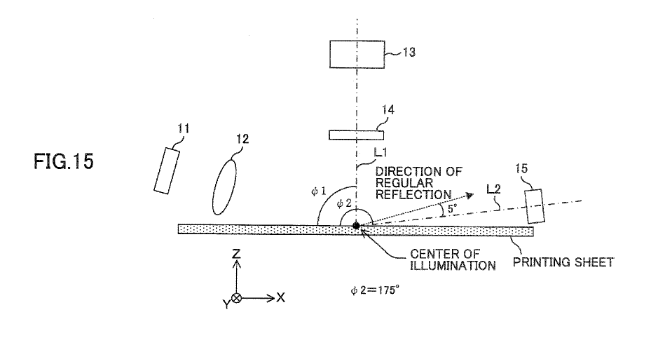

If a reception angle range of the photodetector 15 is equal to ±3 degrees and the photodetector 15 is disposed so that a reflection light beam with the detection angle in a range of 172-178 degrees (which is equivalent to the reflection angle in a range of 82-88 degrees) may be received by the photodetector 15 (see FIG. 15), and therefore the sensitivity of the photodetector 15 can be suited to the plain sheet. By this modification, the brand of a plain sheet can be identified by the optical sensor more finely.

In the above-described embodiment, when the reception angle range of the photodetector 15 is smaller than a desired reception angle range, a condenser lens may be additionally disposed in front of the photodetector 15 in the optical path of the reflection light.

In the foregoing embodiment, the case where the incident light on the printing sheet is s-polarized light has been described. However, the present disclosure is not limited to this embodiment. Alternatively, the incident light on the printing sheet may be p-polarized light. However, in such a case, a polarizing filter which s-polarized light penetrates must be used instead of the polarizing filter 14.

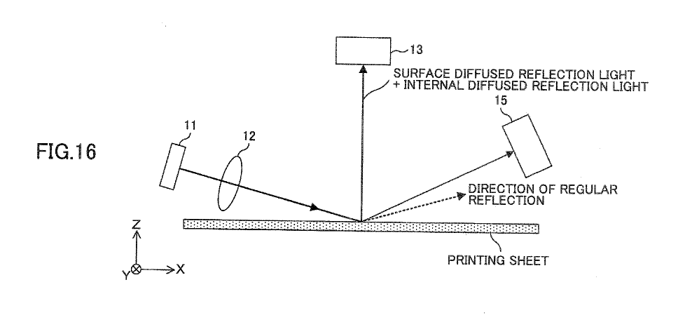

In the above-described embodiment, if the level of sheet kind distinction of the optical sensor 2245 is so high as to identify the distinction of a non-coated sheet, a coated sheet or an OHP sheet, the polarizing filter 14 may be omitted as shown in FIG. 16.

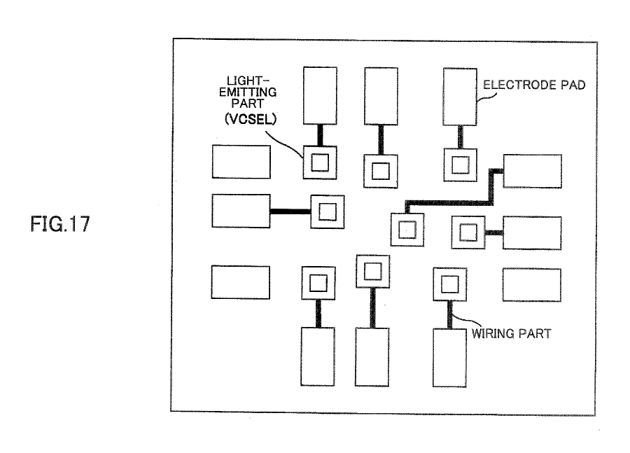

In the surface emitting laser array of the above-described embodiment, the plural light-emitting parts may be arranged such that the intervals of some light-emitting parts differ from the intervals of other light-emitting parts (see FIG. 17). In other words, the intervals of adjacent light-emitting parts in the surface emitting laser array may not equal intervals.

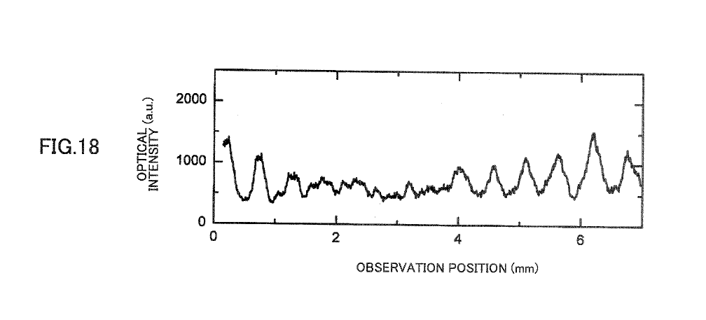

FIG. 18 shows the light intensity distribution of a speckle pattern when the intervals of light-emitting parts are at equal intervals. Specifically, in this example, the light source includes a surface emitting laser array in which five light-emitting parts are arrayed in a one-dimensional formation. The light intensity distribution of the speckle pattern is observed by the beam profiler with the light source in which the light-emitting parts are arrayed at equal intervals. In this case, the periodic oscillation of light intensity corresponding to the regularity of the light-emitting part arrangement was present and the contrast ratio was equal to 0.64.

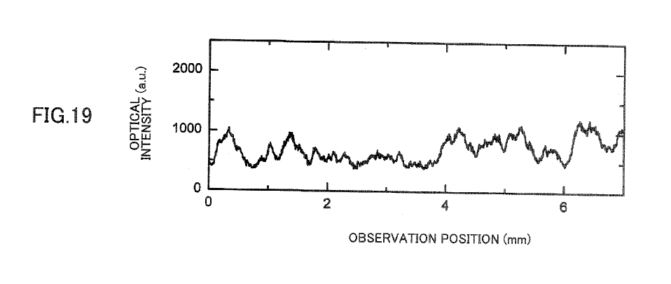

FIG. 19 shows the light intensity distribution of a speckle pattern when the intervals of light-emitting parts are not at equal intervals. Specifically, in this example, the light source includes a surface emitting laser array in which five light-emitting parts are arrayed in a one-dimensional formation. The light intensity distribution of the speckle pattern is observed by the beam profiler with the light source in which the light-emitting parts are arrayed such that the ratio of the intervals of the light-emitting parts p is set to 1.0:1.9:1.3:0.7. In this case, the periodic oscillation of light intensity was prevented and the contrast ratio was 0.56.

Therefore, by using the arrangement of the light-emitting parts in which the light-emitting parts are arrayed at different intervals, the regularity of the speckle pattern can be disturbed and the contrast ratio can be reduced.

In a case where there is a possibility that an error of the sheet kind distinction arises due to the influences of disturbance light or stray light, another photodetector module may be added to the optical sensor.

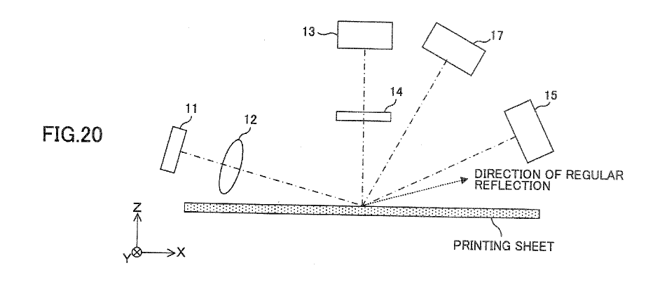

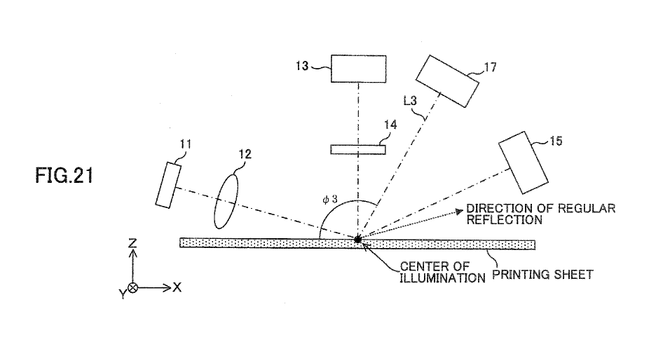

For example, as shown in FIG. 20, a photodetector 17 may be further arranged in the optical sensor as a third photodetector module. The photodetector 17 is disposed in the position where the surface diffused reflection light and the internal diffused reflection light are received by the photodetector 17. In the optical sensor shown in FIG. 20, the center of the light source 11, the center of illumination, the center of the polarizing filter 14, the center of the photodetector 13, the center of the photodetector 15, and the center of the photodetector 17 substantially lie in the same plane. As shown in FIG. 21, a line L3 is drawn to connect the center of illumination and the center of the photodetector 17, and an angle φ3 (see FIG. 21) which the line L3 makes with the surface of the printing sheet is equal to 120 degrees.

In this case, the sheet kind distinction process performed by the printer controller 2090 includes the following steps (1)-(5).

In the following, S3 denotes a signal level of an output signal of the photodetector 17 when the printing sheet is irradiated by the light from the light source 11.

(1) Control the plural light-emitting parts of the optical sensor 2245 to emit light beams simultaneously.

(2) Compute the values of S1, S2 and S3 based on the respective output signals of the photodetectors 13, 15 and 17.

(3) Compute the value of S3/S2.

(4) Identify the brand of the printing sheet by accessing the printing sheet distinction table in the ROM based on the computed values of S1 and S3/S2.

(5) Store the identified brand of the printing sheet in the RAM, and terminate the sheet kind distinction process.

In this case, with respect to plural brands of printing sheets which can be used in the color printer 2000, the values of S1 and S3/S2 are measured in advance for each brand in a pre-shipment process, such as an adjustment process, and the results of the measurement are stored in the ROM of the printer controller 2090 as the printing sheet distinction table.

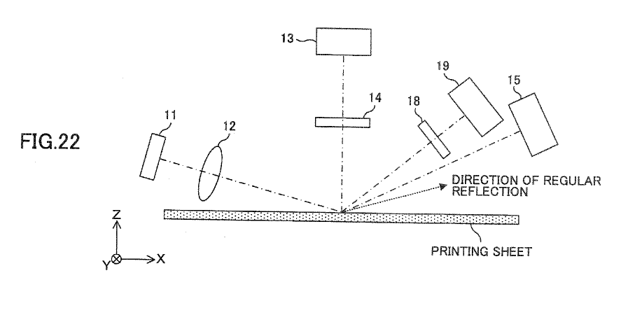

For example, as shown in FIG. 22, a polarizing filter 18 and a photodetector 19 may be further arranged in the optical sensor as the third photodetector module.

The polarizing filter 18 is disposed in the optical path of the surface diffused reflection light and the internal diffused reflection light. This polarizing filter 18 is a polarizing filter which transmits the p-polarized light and cuts off the s-polarized light. The photodetector 19 is disposed in the optical path of the light transmitted through the polarizing filter 18. Hence, the photodetector 19 receives the p-polarized component contained in the internal diffused reflection light.

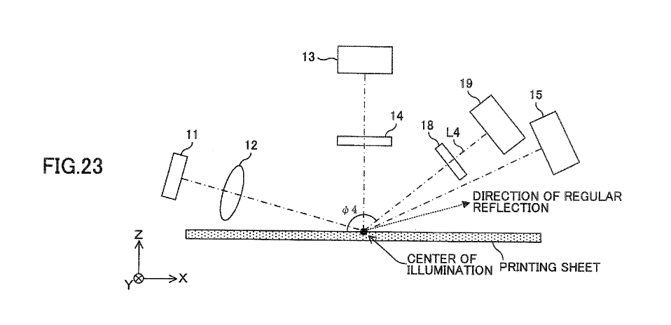

The center of the light source 11, the center of illumination, the center of the polarizing filter 14, the center of the photodetector 13, the center of the photodetector 15, the center of the polarizing filter 18, and the center of the photodetector 19 substantially exist in the same plane. As shown in FIG. 23, a line L4 is drawn to connect the center of illumination, the center of the polarizing filter 18, and the center of the photodetector 19, and an angle φ4 (FIG. 23) which the line L4 makes with the surface of the printing sheet is equal to 150 degrees.

In this case, the sheet kind distinction process performed by the printer controller 2090 includes the following steps (1)-(5).

In the following, S4 denotes a signal level of an output signal of the photodetector 19 when the printing sheet is irradiated by the light from the light source 11.

(1) Control the plural light-emitting parts of the optical sensor 2245 to emit light beams simultaneously.

(2) Compute the values of S1, S2 and S4 based on the respective output signals of the photodetectors 13, 15 and 19.

(3) Compute the value of S4/S1.

(4) Identify the brand of the printing sheet by accessing the printing sheet distinction table in the ROM based on the computed values of S4/S1 and S2.

(5) Store the identified brand of the printing sheet in the RAM, and terminate the sheet kind distinction process.

In this case, with respect to plural brands of printing sheets which can be used in the color printer 2000, the values of S4/S1 and S2 are measured in advance for each brand in a pre-shipment process, such as an adjustment process, and the results of the measurement are stored in the ROM of the printer controller 2090 as the printing sheet distinction table.

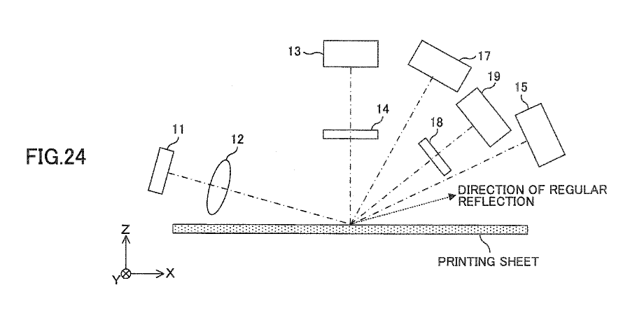

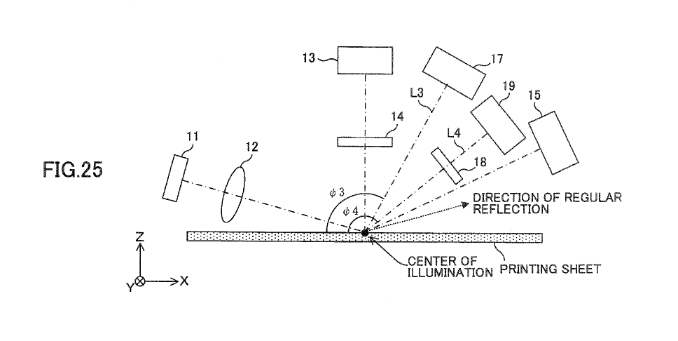

For example, as shown in FIGS. 24 and 25, the above-described photodetector 17, the above-described polarizing filter 18 and the above-described photodetector 19 may be arranged in the optical sensor. Namely, the optical sensor may include the third photodetector module constituted by the photodetector 17, and the fourth photodetector module constituted by the polarizing filter 18 and the photodetector 19.

In this case, the sheet kind distinction processing performed by the printer controller 2090 includes the following steps (1)-(5).

(1) Control the plural light-emitting parts of the optical sensor 2245 to emit light beams simultaneously.

(2) Compute the values of S1, S2, S3 and S4 based on the respective output signals of the photodetectors 13, 15, 17 and 19.

(3) Compute the values of S4/S1 and S3/S2.

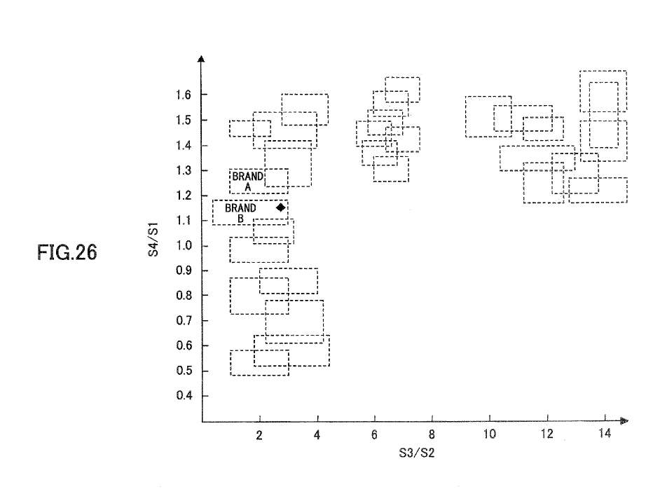

(4) Identify the brand of the printing sheet by accessing the printing sheet distinction table in the ROM based on the computed values of S4/S1 and S3/S2 (see FIG. 26).

(5) Store the identified brand of the printing sheet in the RAM, and terminate the sheet kind distinction process.

In this case, with respect to plural brands of printing sheets which can be used in the color printer 2000, the values of S4/S1 and S3/S2 are measured in advance for each brand in a pre-shipment process, such as an adjustment process, and the results of the measurement are stored in the ROM of the printer controller 2090 as the printing sheet distinction table.

In the above-described modification, the plural light-receiving modules are disposed to detect the diffused light beams reflected in the different directions, respectively, and the kind of the printing sheet is identified based on the computed value of the ratio of the detection values of the light-receiving modules. Hence, even if disturbance light, stray light, etc., are present, exact sheet kind distinction can be carried out.

In this case, the printer controller 2090 may be arranged so that the sheet kind is roughly narrowed down using the values of S1 and S2, and the brand of the printing sheet is identified using the ratios of S4/S1 and S3/S2.

In the above-described modification, S4/S1 is used as an example of the computation step using S1 and S4, but the present disclosure not limited to this example. Similarly, S3/S2 is used as an example of the computation step using S2 and S3, but the present disclosure is not limited to this example.

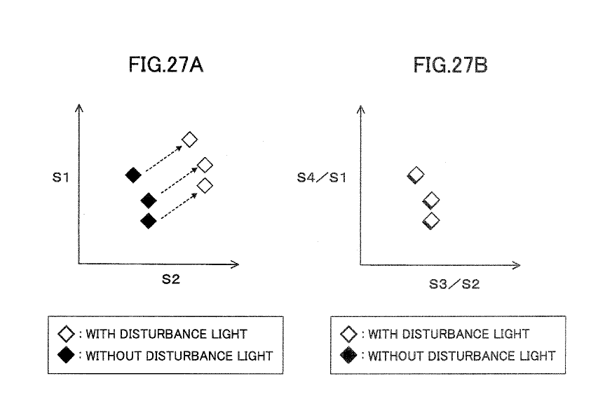

FIG. 27A and FIG. 27B are diagrams for explaining the influences of disturbance light. FIG. 27A and FIG. 27B show the results of investigation of the influences of disturbance light in a case where the sheet kind distinction is carried out using S1 and S2 only, and in a case where the sheet kind distinction is carried out using S4/S1 and S3/S2, respectively.

In the case of FIG. 27A, the sheet kind distinction is carried out using S1 and S2 only, and if there is disturbance light, the detection values of each light-receiving module become large, which may cause an error in the sheet kind distinction. On the other hand, in the case of FIG. 27B, the sheet kind distinction is carried out using S4/S1 and S3/S2. In this case, even if there is disturbance light, S4/S1 and S3/S2 almost remain unchanged from those when no disturbance light is present. Hence, the sheet kind distinction can be correctly carried out.

Alternatively, in this case, the third photodetector module may include plural photodetectors. The fourth photodetector module may include plural sets of polarizing filters and photodetectors.

For example, when the third photodetector module includes two photodetectors and the fourth photodetector module includes two sets of polarizing filters and photodetectors, the sheet kind distinction may be performed using the value of (S4/S1+S6/S1) and the value of (S3/S2+S5/S2) where S3 and S5 denote output signal levels of the photodetectors of the third photodetector module, and S4 and S6 denote output signal levels of the photodetectors of the fourth photodetector module, respectively.

Alternatively, the sheet kind distinction may be performed using the value of S4/S1, the value of S6/S1, the value of S3/S2, and the value of S5/S2.

Similarly, in the above-described modifications, the printing sheet distinction table is prepared in advance in a pre-shipment process, such as an adjustment process, in accordance with the computation process used for the sheet kind distinction and the printing sheet distinction table is stored in the ROM of the printer controller 2090.

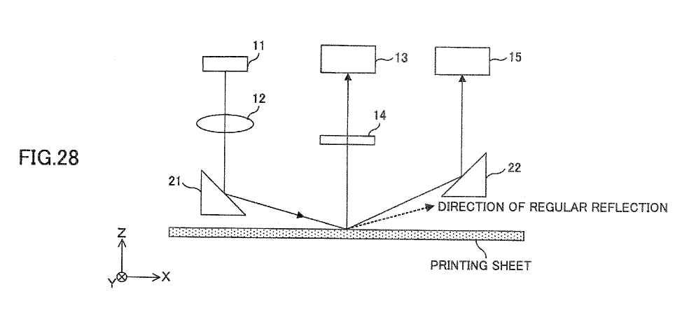

Alternatively, the optical sensor 2245 in the above-described embodiment may be arranged to further include two mirrors 21, 22 as shown in FIG. 28.

In the present embodiment, the light source 11 is disposed to emit light beams in the direction parallel to the Z-axis, and the collimating lens 12 is disposed to have an optical axis parallel to the Z-axis, as shown in FIG. 28. The mirror 21 is disposed to reflect the light having passed through the collimating lens 12 so that the angle of incidence of the reflected light on the printing sheet is equal to 80 degrees.

The mirror 22 (which is identical to the mirror 21) is disposed in a position in the X-axis orientation where the mirror 22 faces the mirror 21 via the opening of the black box 16. The mirror 22 reflects the surface regular reflection light from the surface of the printing sheet in a direction parallel to the Z-axis.

The photodetector 15 is disposed on the +Z side of the mirror 22 to receive the reflection light reflected by the mirror 22. Also, in this case, the photodetector 15 is disposed so that a reflected light beam having a reflection angle from the normal of the printing sheet surface in a range of 70 to 80 degrees is received by the photodetector 15.

In this case, the use of a supporting component for supporting the light source 11, the collimating lens 12 and the photodetector 15 in the inclined state may be omitted and the electrical circuit may be simplified. Hence, the cost and the size of the optical sensor can be reduced.

Even when three or more photodetectors are disposed in the optical sensor, the miniaturization of the optical sensor can be promoted by using the mirrors to change the optical path of the light incident on each of the photodetectors in the direction parallel to the Z-axis.

In the foregoing embodiments, the case in which the light source 11 includes nine light-emitting parts has been described. However, the present disclosure is not limited to these embodiments.

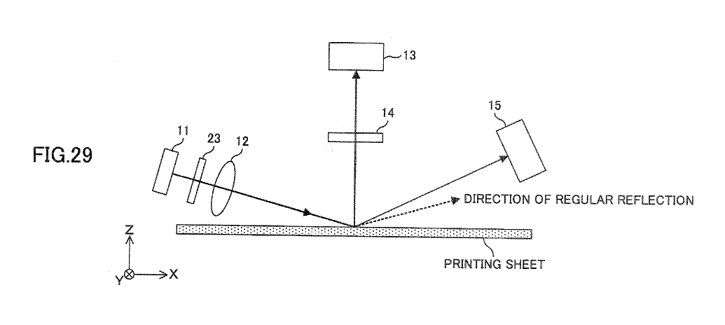

In the foregoing embodiments, the case in which the light source 11 emits a linearly polarized light beam has been described. However, the present disclosure is not limited to these embodiments. In a case in which the emission light from the light source is not linearly polarized, as shown in FIG. 29, it is required to use a polarizing filter 23 which converts the emission light from the light source 11 into an s-polarized light beam.

In the foregoing embodiments, it is preferred to dispose a condenser lens in front of the photodetector 13. In this case, variations of the amount of light received by the photodetector 13 can be reduced with the condenser lens.

In the foregoing embodiments, a processing unit may be arranged in the optical sensor 2245, and a part of the processing of the printer controller 2090 may be performed by the processing unit of the optical sensor.

In the foregoing embodiments, the color printer in which one sheet feed tray is provided has been described. However, the present disclosure is not limited to the color printer and applicable to image forming devices in which two or more sheet feed trays are provided. In such a case, two or more optical sensors 2245 may be provided for the sheet feed trays, respectively.

Alternatively, in the foregoing embodiments, the brand of a printing sheet during transport may be identified. In this case, the optical sensor 2245 is disposed near a sheet transport passage. For example, the optical sensor 2245 may be disposed near the sheet transport passage between the feed roller 2504 and the transfer roller 2042.

The object identified by the optical sensor 2245 is not limited to printing sheets.

In the foregoing embodiments, the color printer 2000 has been described as an image forming device. However, the present disclosure is not limited to the color printer. For example, the present disclosure may be applied to a laser printer which forms a monochrome image, and also applicable to image forming devices other than printers, such as copiers, facsimile devices, and multi-function peripherals.

In the foregoing embodiments, the case in which the image forming device includes four photoconductor drums has been described. However, the present disclosure is not limited to this image forming device. For example, the present disclosure is applicable to a printer including five photoconductor drums.

In the foregoing embodiments, the image forming device in which toner images from the photoconductor drums are transferred to a printing sheet through the transfer belt has been described. However, the present disclosure is not limited to this image forming device. The present disclosure is applicable to an image forming device in which a toner image from a photoconductor drum is directly transferred to a printing sheet.

The optical sensor 2245 according to the present disclosure is also applicable to an image forming device which ejects ink to a printing sheet to form an image on the printing sheet.

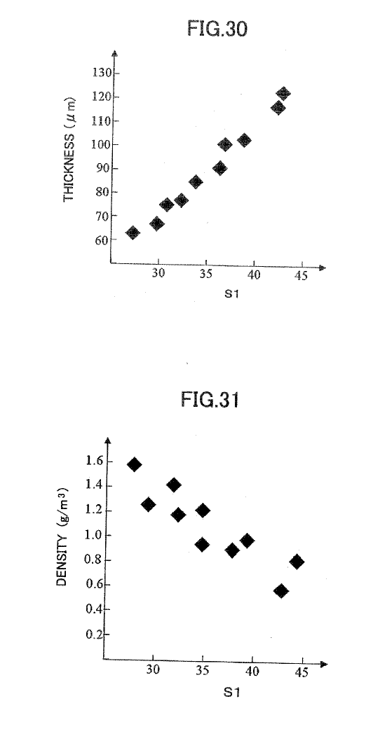

The optical sensor 2245 according to the present disclosure is applicable to detection of a thickness of a sheet (see FIG. 30). The thickness sensor according to the related art is a transmission type sensor and it is required to dispose two optical systems on both sides of a sheet to sandwich the sheet between the optical systems. Therefore, a supporting component must be disposed to support the optical systems. However, in the optical sensor 2245 according to the present disclosure, one optical system may be disposed on one side of a sheet to detect the thickness of the sheet based on the reflection light from the surface of the sheet. Hence, the number of component parts can be reduced to reduce the cost and the size of the optical sensor. The optical sensor 2245 according to the present disclosure is appropriate for use in an image forming device which requires detection of a thickness of a sheet.

The optical sensor 2245 according to the present disclosure is applicable to detection of a density of a sheet (see FIG. 31). The density sensor according to the related art is a transmission type sensor and it is required to dispose two optical systems on both sides of a sheet to sandwich the sheet between the optical systems. Therefore, a supporting component must be disposed to support the optical systems. However, in the optical sensor 2245 according to the present disclosure, one optical system may be disposed on one side of a sheet to detect the density of the sheet based on the reflection light from the surface of the sheet. Hence, the number of component parts can be reduced to reduce the cost and the size of the optical sensor. The optical sensor 2245 according to the present disclosure is appropriate for use in an image forming device which requires detection of the density of a sheet.

Furthermore, the optical sensor 2245 according to the present disclosure is applicable to detection of the smoothness of a sheet. In this case, the basic characteristics of a sheet, such as the thickness, the density and the smoothness of a printing sheet, can be captured from the output of the optical sensor, and the optimal image formation conditions for the printing sheet can be estimated.

As described in the foregoing, the optical sensor according to the present disclosure can identify a kind of a sheet more finely than in the related art without increasing the device cost and the size.

The optical sensor according to the present disclosure is not limited to the above-described embodiments, and variations and modifications may be made without departing from the scope of the present disclosure.

The present application is based upon and claims the benefit of priority of Japanese Patent Application No. 2012-051096, filed on Mar. 8, 2012, the contents of which are incorporated herein by reference in their entirety.

What is claimed is:

1. An optical sensor comprising:
a light emission module to emit a linearly polarized light beam having a first polarizing direction to a surface of an object in an incident direction inclined relative to a direction of a normal to the object surface;
a first photodetector module including a first photodetector disposed within a plane of incidence of the object surface in an optical path inclined relative to an optical path of the light beam emitted from the light emission module and regularly reflected on the object surface; and
a second photodetector module including an optical element disposed within the plane of incidence of the object surface in an optical path of a diffused reflection light beam from the object surface to separate a linearly polarized light beam having a second polarizing direction perpendicular to the first polarizing direction, and a second photodetector to receive the light beam having the second polarizing direction separated by the optical element.

2. The optical sensor according to claim 1, wherein the first photodetector is disposed in the optical path inclined at an angle of 10 degrees or smaller relative to the optical path of the regularly reflected light beam.

3. The optical sensor according to claim 1, wherein an angle of a direction of the optical path in which the first photodetector module is disposed, inclined relative to the direction of the normal to the object surface, is smaller than an angle of the regular reflection and 10 degrees or smaller relative to a direction of the regularly reflected light beam.

4. The optical sensor according to claim 1, wherein the optical element and the second photodetector are disposed in the optical path of the light beam which is diffuse reflected in the direction of the normal to the object surface.

5. The optical sensor according to claim 1, further comprising a control unit is configured to identify a kind of the object based on an output signal of the first photodetector and an output signal of the second photodetector.

6. The optical sensor according to claim 1, further comprising a third photodetector module including at least one photodetector disposed within the plane of incidence of the object surface in an optical path of a light beam diffuse reflected on the object surface; and
a control unit configured to identify a kind of the object based on an output signal of the second photodetector and a ratio of an output signal of the at least one photodetector of the third photodetector module to an output signal of the first photodetector.

7. The optical sensor according to claim 1, further comprising:
a third photodetector module including at least one optical element disposed within the plane of incidence of the object surface in an optical path of a light beam diffuse reflected on the object surface to transmit a linearly polarized light beam having the second polarizing direction, and at least one photodetector to receive the light beam transmitted through the at least one optical element; and
a control unit configured to identify a kind of the object based on an output signal of the first photodetector and a ratio of an output signal of the at least one photodetector of the third photodetector module to an output signal of the second photodetector.

8. The optical sensor according to claim 1, further comprising:
a third photodetector module including at least one photodetector disposed within the plane of incidence of the object surface in an optical path of a light beam diffuse reflected on the object surface;
a fourth photodetector module including at least one optical element disposed within the plane of incidence of the object surface in an optical path of a light beam diffuse reflected on the object surface to transmit a linearly polarized light beam having the second polarizing direction, and at least one photodetector to receive the light beam transmitted through the at least one optical element; and
a control unit configured to identify a kind of the object based on a ratio of an output signal of the at least one photodetector of the third photodetector module to an output signal of the second photodetector, and a ratio of an output signal of the at least one photodetector of the fourth photodetector module to an output signal of the first photodetector.

9. The optical sensor according to claim 1, wherein the light emission module comprises a surface emitting laser array including plural light-emitting parts arranged in a two-dimensional formation.

10. An image forming device comprising:
the optical sensor according to claim 1 configured to output a signal in response to reflection light beams reflected from a surface of a recording medium;
an image formation unit configured to form an image on the recording medium in accordance with image information; and
a control unit configured to identify a brand of the recording medium based on the output signal of the optical sensor and adjust image forming conditions of the image formation unit based on the brand of the recording medium.
